(19) United States
(12) Patent Application Publication
(10) Pub. No.: US 2026/0153642 A1
(43) Pub. Date: Jun. 4, 2026

(54) R1D Image Processing of Azimuthal Electromagnetic Pipe Inspection Data

(71) Applicant: Halliburton Energy Services, Inc., Houston, TX (US)

(72) Inventors: Huiwen Sheng, Singapore (SG); Ahmed Fouda, Houston, TX (US)

(73) Assignee: Halliburton Energy Services, Inc., Houston, TX (US)

(21) Appl. No.: 19/406,822

(22) Filed: Dec. 2, 2025

Related U.S. Application Data
(60) Provisional application No. 63/727,772, filed on Dec. 4, 2024.

(51) Int. Cl. G01V 3/38; E21B 47/002; G01V 3/28

(52) U.S. Cl. CPC G01V 3/38; E21B 47/0025; G01V 3/28; E21B 2200/20

(57) ABSTRACT

A method that may include disposing an electromagnetic (EM) logging tool in a wellbore. The EM logging tool may include one or more transmitters disposed on the EM logging tool and one or more receivers disposed on the EM logging tool. The method may further include transmitting an electromagnetic field from the transmitter into one or more tubulars to energize the one or more tubulars with the electromagnetic field thereby producing an eddy current that emanates from the one or more tubulars, measuring the eddy current in the one or more tubulars with the receiver on at least one channel to obtain a plurality of measurements, and forming an EM log from the plurality of measurements.

### CROSS REFERENCE TO RELATED APPLICATIONS

This application claims the priority of U.S. Provisional Patent Application No. 63/727,772, filed Dec. 4, 2024, which is incorporated by reference in its entirety.

### BACKGROUND

For oil and gas exploration and production, a network of wells, installations and other conduits may be established by connecting sections of metal pipe together. For example, a well installation may be completed, in part, by lowering multiple sections of metal pipe (e.g., a casing string) into a wellbore, and cementing the casing string in place. In some well installations, multiple casing strings are employed (e.g., a concentric multi-string arrangement) to allow for different operations related to well completion, production, or enhanced oil recovery (EOR) options.

Electromagnetic (EM) techniques are commonly used to monitor the condition of the pipes in oil/gas wellbore including various kinds of casing strings and tubing. One common EM technique utilizes eddy current (EC). In EC, when the transmitter coil emits the primary transient EM fields, eddy currents are induced in the casing. These eddy currents then produce secondary fields which are received along with the primary fields by the receiver coil. The acquired data may then be employed to perform evaluation of the multiple pipes.

Early detection of metal loss of well components, like production tubing or casing, is of great importance to oil and gas wells management. Currently, the remote field eddy current tools may detect anomalies on multiple nested tubulars. However, this type of tool has low vertical resolution, and it has no azimuthal discrimination. That means the estimated metal loss is an average value of annular section of the pipe within the tool vertical resolution range. Therefore, it may fail to detect tubular anomalies, such as cracks, pitting, holes, and any metal loss due to corrosion may result in expensive remedial actions and shut down of production wells. Additionally, identifying tubular anomalies in outer pipes or anomalies found on out pipes behind inner anomalies may be difficult.

### BRIEF DESCRIPTION OF THE DRAWINGS

These drawings illustrate certain aspects of some examples of the present disclosure and should not be used to limit or define the disclosure.

FIG. 1 illustrates an example of an EM logging tool disposed in a wellbore;

FIG. 2 illustrates an example of arbitrary defects within multiple pipes;

FIG. 3A illustrates an example of an EM logging tool traversing a wellbore;

FIG. 3B illustrates another example of an EM logging tool traversing a wellbore;

FIG. 3C illustrates another example of an EM logging tool traversing a wellbore;

FIG. 3D illustrates another example of an EM logging tool traversing a wellbore;

FIG. 3E illustrates another example of an EM logging tool traversing a wellbore;

FIG. 4 illustrates an example of a well plan;

FIG. 5 illustrates a schematic of an information handling system;

FIG. 6 illustrates a schematic of a chip set;

FIG. 7 illustrates a computing network;

FIG. 8 illustrates a neural network;

FIG. 9 is a workflow for identifying if anomalies are overlapping or non-overlapping;

FIG. 10 illustrates simultaneously excited r coil crown that may mimic two z coils with opposite polarity;

FIGS. 11A-11D are graphs showing measurements taken by the EM logging tool;

FIG. 12A-12D are graphs of another example showing measurements taken by the EM logging tool;

FIGS. 13A & 13B are graphs of a R1D inversion misfit for different measurement scenarios;

FIGS. 14A & 14B are graphs of another example of a R1D inversion misfit for different measurement scenarios;

FIG. 15 illustrates a workflow to resolve the thickness of defected pipe using optimized weights;

FIGS. 16A & 16B are graphs illustrating the use of workflow in FIG. 15;

FIGS. 17A & 17B are graphs from another example illustrating the use of workflow in FIG. 15;

FIG. 18A-18E are graphs showing the final results of workflow of FIG. 15 with overlapping anomalies; and

FIGS. 19A-19E are graphs showing the final results of workflow of FIG. 15 with non-overlapping anomalies.

### DETAILED DESCRIPTION

This disclosure may generally relate to pipe inspection in subterranean wells and, more particularly, to methods and systems for estimating metal loss in multiple nested pipes. Electromagnetic (EM) sensing may provide continuous in-situ measurements of parameters related to the integrity of pipes in cased boreholes. As a result, EM sensing may be used in cased borehole monitoring applications. EM logging tools may be configured for multiple concentric pipes (e.g., for one or more) with the first pipe diameter varying (e.g., from about two inches to about seven inches or more).

EM logging tools may measure eddy currents to determine metal loss, location of collars, and use magnetic cores with one or more coils to detect defects in multiple concentric pipes. The EM logging tools may use pulse eddy current (time-domain) and may employ multiple (long, short, and transversal) coils to evaluate multiple types of defects in multiple concentric pipes. It should be noted that the techniques utilized in time-domain may be utilized in frequency-domain measurements. In examples, EM logging tools may operate on a conveyance. Additionally, EM logging tools may include an independent power supply and may store the acquired data on memory.

Monitoring the condition of the production and intermediate casing strings is crucial in oil and gas field operations. EM eddy current (EC) techniques have been successfully used in inspection of these components. EM EC techniques may comprise categories: frequency-domain EC techniques, time-domain EC techniques, and/or a hybrid domain of both. In both techniques, one or more transmitters are excited with an excitation signal, and the signals from the pipes are received and recorded for interpretation. The magnitude of a received signal is typically inversely proportional to the amount of metal that is present in the inspection location. For example, less signal magnitude is typically an indication of more metal, and more signal magnitude is an indication of less metal or more metal. This relationship may allow for measurements of metal loss, which typically is due to an anomaly related to the pipe such as corrosion or buckling. Metal gain may indicate the presence of a collar.

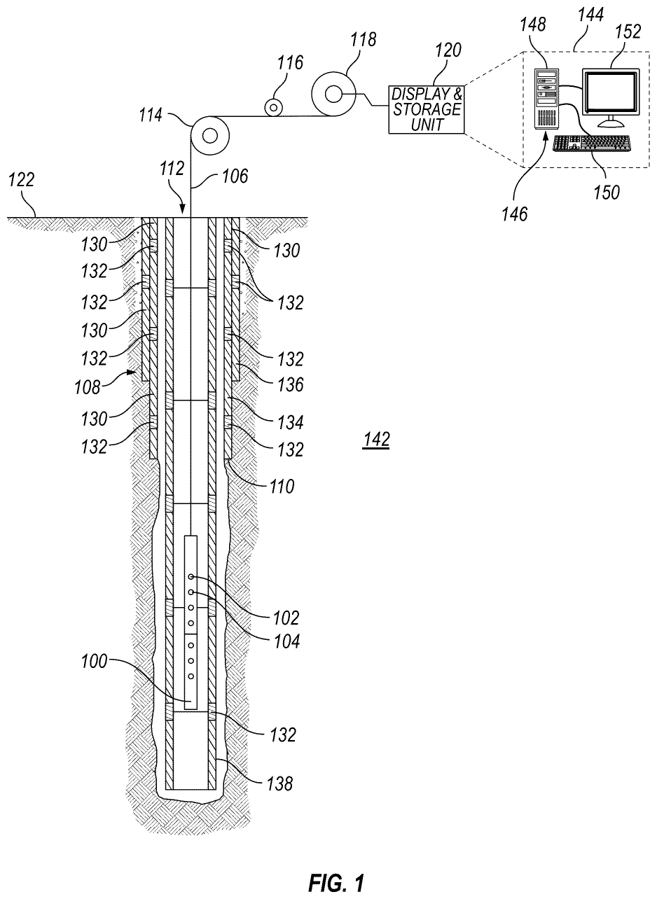

FIG. 1 illustrates an operating environment for an EM logging tool 100 as disclosed herein in accordance with some embodiments. EM logging tool 100 may comprise a transmitter 102 and/or a receiver 104. In examples, transmitters 102 and receivers 104 may be one or more coils, one or more antennas, or one or more electromagnetic elements. Furthermore, transmitter 102 and receiver 104 may be separated by a space between about 0.1 inches (0.254 cm) to about 200 inches (508 cm). In examples, EM logging tool 100 may be an induction tool that may operate with continuous wave execution of at least one frequency, a pulsed wave, or a broadband of signals. This may be performed with any number of transmitters 102 and/or any number of receivers 104, which may be disposed on EM logging tool 100. In additional examples, transmitter 102 may function and/or operate as a receiver 104 or vice versa. EM logging tool 100 may be operatively coupled to a conveyance 106 (e.g., wireline, slickline, coiled tubing, pipe, downhole tractor, and/or the like) which may provide mechanical suspension, as well as electrical connectivity, for EM logging tool 100. Conveyance 106 and EM logging tool 100 may extend within casing string 108 to a desired depth within the wellbore 110. Conveyance 106, which may include one or more electrical conductors, may exit wellhead 112, may pass around pulley 114, may engage odometer 116, and may be reeled onto winch 118, which may be employed to raise and lower the tool assembly in wellbore 110.

Signals recorded by EM logging tool 100 may be stored on memory and then processed by display and storage unit 120 after recovery of EM logging tool 100 from wellbore 110. Alternatively, signals recorded by EM logging tool 100 may be conducted to display and storage unit 120 by way of conveyance 106. Display and storage unit 120 may process the signals, and the information contained therein may be displayed for an operator to observe and stored for future processing and reference. It should be noted that an operator may include an individual, group of individuals, or organization, such as a service company. Alternatively, signals may be processed downhole prior to receipt by display and storage unit 120 or both downhole and at surface 122, for example, by display and storage unit 120. Display and storage unit 120 may also contain an apparatus for supplying control signals and power to EM logging tool 100 in casing string 108.

A typical casing string 108 may extend from wellhead 112 at or above ground level to a selected depth within a wellbore 110. Casing string 108 may comprise a plurality of joints 130 or segments of casing string 108, each joint 130 being connected to the adjacent segments by a collar 132. There may be any number of layers in casing string 108. Such as, a first casing 134 and a second casing 136. It should be noted that there may be any number of casing layers.

FIG. 1 also illustrates a typical pipe string 138, which may be positioned inside of casing string 108 extending part of the distance down wellbore 110. Pipe string 138 may be production tubing, tubing string, casing string, or other pipe disposed within casing string 108. Pipe string 138 may comprise concentric pipes. It should be noted that concentric pipes may be connected by collars 132. EM logging tool 100 may be dimensioned so that it may be lowered into the wellbore 110 through pipe string 138, thus avoiding the difficulty and expense associated with pulling pipe string 138 out of wellbore 110.

EM logging tool 100 may include a digital telemetry system which may further include one or more electrical circuits, not illustrated, to supply power to EM logging tool 100 and to transfer data between display and storage unit 120 and EM logging tool 100. A DC voltage may be provided to EM logging tool 100 by a power supply located above ground level, and data may be coupled to the DC power conductor by a baseband current pulse system. Alternatively, EM logging tool 100 may be powered by batteries located within EM logging tool 100 and data provided by EM logging tool 100 may be stored within EM logging tool 100, rather than transmitted to the surface to display and storage unit 120 during logging operations. The data may include signals and measurements related to corrosion detection.

During operations, transmitter 102 may broadcast electromagnetic fields into subterranean formation 142. It should be noted that broadcasting electromagnetic fields may also be referred to as transmitting electromagnetic fields. The electromagnetic fields transmitted from transmitter 102 may be referred to as a primary electromagnetic field. The primary electromagnetic fields may produce Eddy currents in casing string 108 and pipe string 138. These Eddy currents, in turn, produce secondary electromagnetic fields that may be sensed and/or measured by receivers 104. Characterization of casing string 108 and pipe string 138, including determination of pipe attributes, may be performed by measuring and processing primary and secondary electromagnetic fields. Pipe attributes may include, but are not limited to, pipe thickness, pipe conductivity, and/or pipe permeability.

As illustrated, receivers 104 may be positioned on EM logging tool 100 at selected distances (e.g., axial spacing) away from transmitters 102. The axial spacing of receivers 104 from transmitters 102 may vary, for example, from about 0 inches (0 cm) to about 40 inches (101.6 cm) or more. It should be understood that the configuration of EM logging tool 100 shown in FIG. 1 is merely illustrative and other configurations of EM logging tool 100 may be used with the present techniques. A spacing of 0 inches (0 cm) may be achieved by collocating coils with different diameters. While FIG. 1 shows only a single array of receivers 104, there may be multiple sensor arrays where the distance between transmitter 102 and receivers 104 in each of the sensor arrays may vary. In addition, EM logging tool 100 may include more than one transmitter 102 and more or less than six receivers 104. In addition, transmitter 102 may be a coil implemented for transmission of magnetic field while also measuring EM fields, in some instances. Where multiple transmitters 102 are used, their operation may be multiplexed or time multiplexed. For example, a single transmitter 102 may broadcast, for example, a multi-frequency signal or a broadband signal. While not shown, EM logging tool 100 may include a transmitter 102 and receiver 104 that are in the form of coils or solenoids coaxially positioned within a downhole tubular (e.g., casing string 108) and separated along the tool axis. Alternatively, EM logging tool 100 may include a transmitter 102 and receiver 104 that are in the form of coils or solenoids coaxially positioned within a downhole tubular (e.g., casing string 108) and collocated along the tool axis.

Broadcasting of EM fields by transmitter 102 and the sensing and/or measuring of secondary electromagnetic fields by receivers 104 may be controlled by display and storage unit 120, which may include an information handling system 144. As illustrated, the information handling system 144 may be a component of or be referred to as the display and storage unit 120, or vice-versa. Alternatively, the information handling system 144 may be a component of EM logging tool 100. An information handling system 144 may include any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price.

Information handling system 144 may include a processing unit 146 (e.g., microprocessor, central processing unit, etc) that may process EM log data by executing software or instructions obtained from a local non-transitory computer readable media 148 (e.g., optical disks, magnetic disks). The non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with EM logging tool 100 and/or software executed by processing unit 146. For example, information handling system 144 may enable an operator to select analysis options, view collected log data, view analysis results, and/or perform other tasks.

EM logging tool 100 may use any suitable EM technique based on Eddy current (“EC”) for inspection of concentric pipes (e.g., casing string 108 and pipe string 138). EC techniques may be particularly suited for characterization of a multi-string arrangement in which concentric pipes are used. EC techniques may include, but are not limited to, frequency-domain EC techniques and time-domain EC techniques.

In frequency domain EC techniques, transmitter 102 of EM logging tool 100 may be fed by a continuous sinusoidal signal, producing primary magnetic fields that illuminate the concentric pipes (e.g., casing string 108 and pipe string 138). The primary electromagnetic fields produce Eddy currents in the concentric pipes. These Eddy currents, in turn, produce secondary electromagnetic fields that may be sensed and/or measured with the primary electromagnetic fields by receivers 104. Characterization of the concentric pipes may be performed by measuring and processing these electromagnetic fields.

In time domain EC techniques, which may also be referred to as pulsed EC (“PEC”), transmitter 102 may be fed by a pulse. Transient primary electromagnetic fields may be produced due to the transition of the pulse from “off” to “on” state or from “on” to “off” state (more common). These transient electromagnetic fields produce EC in the concentric pipes (e.g., casing string 108 and pipe string 138). The EC, in turn, produces secondary electromagnetic fields that may be sensed and/or measured by receivers 104 placed at some distance on EM logging tool 100 from transmitter 102, as shown on FIG. 1. Alternatively, the secondary electromagnetic fields may be sensed and/or measured by a co-located receiver (not shown) or with transmitter 102 itself.

It should be understood that while casing string 108 is illustrated as a single casing string, there may be multiple layers of concentric pipes disposed in the section of wellbore 110 with casing string 108. EM log data may be obtained in two or more sections of wellbore 110 with multiple layers of concentric pipes. For example, EM logging tool 100 may make a first measurement of pipe string 138 comprising any suitable number of joints 130 connected by collars 132. Measurements may be taken in the time-domain and/or frequency range. EM logging tool 100 may make a second measurement in a casing string 108 of first casing 134, wherein first casing 134 comprises any suitable number of pipes connected by collars 132. Measurements may be taken in the time-domain and/or frequency domain. These measurements may be repeated any number of times for first casing 134, for second casing 136, and/or any additional layers of casing string 108. In this disclosure, as discussed further below, methods may be utilized to determine the location of any number of collars 132 in casing string 108 and/or pipe string 138. Determining the location of collars 132 in the frequency domain and/or time domain may allow for accurate processing of recorded data in determining properties of casing string 108 and/or pipe string 138 such as corrosion. As mentioned above, measurements may be taken in the frequency domain and/or the time domain.

In frequency domain EC, the frequency of the excitation may be adjusted so that multiple reflections in the wall of the pipe (e.g., casing string 108 or pipe string 138) are insignificant, and the spacing between transmitters 102 and/or receiver 104 is large enough that the contribution to the mutual impedance from the dominant (but evanescent) waveguide mode is small compared to the contribution to the mutual impedance from the branch cut component. In examples, a remote-field eddy current (RFEC) effect may be observed. In an RFEC regime, the mutual impedance between the coil of transmitter 102 and coil of one of the receivers 104 may be sensitive to the thickness of the pipe wall. To be more specific, the phase of the impedance varies as:

$$φ = 2 \sqrt{\frac{ωμσ}{2}} t \qquad ( 1 )$$

and the magnitude of the impedance shows the dependence:

$$exp [ - 2 ( \sqrt{\frac{ωμσ}{2}} ) t ] \qquad ( 2 )$$

where ω is the angular frequency of the excitation source, μ is the magnetic permeability of the pipe, σ is the electrical conductivity of the pipe, and t is the thickness of the pipe. By using the common definition of skin depth for the metals as:

$$δ = \sqrt{\frac{2}{ωμσ}} \qquad ( 3 )$$

The phase of the impedance varies as:

$$φ ≅ 2 \frac{t}{δ} \qquad ( 4 )$$

and the magnitude of the impedance shows the dependence:

$$exp [ \frac{- 2 t}{δ} ] \qquad ( 5 )$$

In RFEC, the estimated quantity may be the overall thickness of the metal. Thus, for multiple concentric pipes, the estimated parameter may be the overall or sum of the thickness of the pipes. The quasi-linear variation of the phase of mutual impedance with the overall metal thickness may be employed to perform fast estimation to estimate the overall thickness of multiple concentric pipes. For this purpose, for any given set of pipes dimensions, material properties, and tool configuration, such linear variation may be constructed quickly and may be used to estimate the overall thickness of concentric pipes. Information handling system 144 may enable an operator to select analysis options, view collected log data, view analysis results, and/or perform other tasks.

Monitoring the condition of pipe string 138 and casing string 108 may be performed on information handling system 144 in oil and gas field operations. Information handling system 144 may be utilized with Electromagnetic (EM) Eddy Current (EC) techniques to inspect pipe string 138 and casing string 108. EM EC techniques may include frequency-domain EC techniques and time-domain EC techniques. In time-domain and frequency-domain techniques, one or more transmitters 102 may be excited with an excitation signal which broadcast an electromagnetic field and receiver 104 may sense and/or measure the reflected excitation signal, a secondary electromagnetic field, for interpretation. The received signal is proportional to the amount of metal that is around transmitter 102 and receiver 104. For example, less signal magnitude is typically an indication of more metal, and more signal magnitude is an indication of less metal. This relationship may be utilized to determine metal loss, which may be due to an abnormality related to the pipe such as corrosion or buckling.

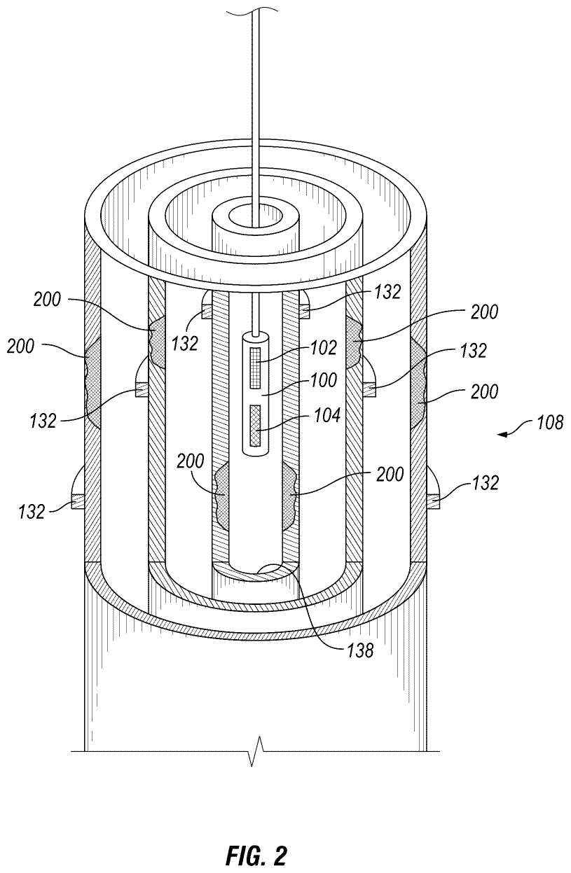

FIG. 2 shows EM logging tool 100 disposed in pipe string 138 which may be surrounded by a plurality of nested pipes (e.g., first casing 134 and second casing 136) and an illustration of anomalies 200 disposed within the plurality of nested pipes, in accordance with some embodiments. As EM logging tool 100 moves across pipe string 138 and casing string 108, one or more transmitters 102 may be excited, and a signal (mutual impedance between 102 transmitter and receiver 104) at one or more receivers 104, may be recorded.

Due to eddy current physics and electromagnetic attenuation, pipe string 138 and/or casing string 108 may generate an electrical signal that is in the opposite polarity to the incident signal and results in a reduction in the received signal. Typically, more metal volume translates to more lost signals. As a result, by inspecting the signal gains, it is possible to identify zones with metal loss (such as corrosion). In order to distinguish signals that originate from anomalies at different pipes of a multiple nested pipe configuration, multiple transmitter-receiver spacing, and frequencies may be utilized. For example, short-spaced transmitters 102 and receivers 104 may be sensitive to first casing 134, while longer spaced transmitters 102 and receivers 104 may be sensitive to second casing 136 and/or deeper (3rd, 4th, etc.) pipes. By analyzing the signal levels at these different channels with inversion methods, it is possible to relate a certain received signal to a certain metal loss or gain at each pipe. In addition to loss of metal, other pipe properties such as magnetic permeability and conductivity may also be estimated by inversion methods. It should be noted that inversion methods may include model-based inversion which may include forward modeling. However, there may be factors that complicate interpretation of losses. For example, deep pipe signals may be significantly lower than other signals. Double dip indications appear for long spaced transmitters 102 and receivers 104. Spatial spread of long spaced transmitter-receiver signals for a collar 132 may be long (up to 6 feet (1.8 meters)). Due to these complications, methods may need to be used to accurately inspect pipe features.

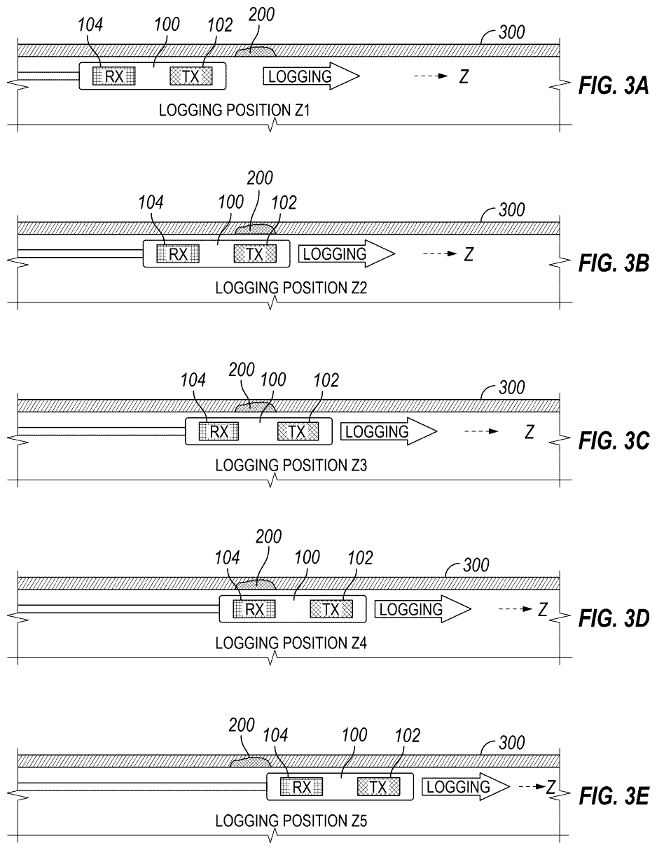

FIGS. 3A-3E illustrate an electromagnetic inspection and detection of anomalies 200 (e.g., defects) or collars 132 (e.g., Referring to FIG. 2), in accordance with some embodiments. As illustrated, EM logging tool 100 may be disposed in pipe string 138, by a conveyance, which may comprise any number of concentric pipes. As EM logging tool 100 traverses across pipe 300, one or more transmitters 102 may be excited, and a signal (mutual impedance between transmitter 102 and receiver 104) at one or more receivers 104, may be recorded. Due to eddy currents and electromagnetic attenuation, pipe 300 may generate an electrical signal that is in the opposite polarity to the incident signal and results in a reduction in a received signal. Thus, more metal volume translates to greater signal lost. As a result, by inspecting the signal gains, it may be possible to identify zones with metal loss (such as corrosion). Similarly, by inspecting the signal loss, it may be possible to identify metal gain such as due to presence of a casing collar 132 (e.g., Referring to FIG. 1) where two pipes meet with a threaded connection. In order to distinguish signals from different pipes in a multiple concentric pipe configuration, multiple transmitter-receiver spacing, and frequencies may be used. For example, short-spaced transmitters 102 and receivers 104 may be sensitive to pipe string 138, while long spaced transmitters 102 and receivers 104 may be sensitive to deeper pipes (e.g., first casing 124, second casing 136, etc.). By analyzing the signal levels at these different channels through a process of inversion, it may be possible to relate a certain received signal set to a certain set of metal loss or gain at each pipe. In examples, there may be factors that complicate the interpretation and/or identification of collars 132 and/or anomalies 200 (e.g., defects).

For example, due to eddy current physics and electromagnetic attenuation, pipes disposed in pipe string 138 (e.g., referring to FIG. 1 and FIG. 2) may generate an electrical signal that may be in the opposite polarity to the incident signal and results in a reduction in the received signal. Generally, as metal volume increases the signal loss may increase. As a result, by inspecting the signal gains, it may be possible to identify zones with metal loss (such as corrosion). In order to distinguish signals that originate from anomalies 200 (e.g., defects) at different pipes of a multiple nested pipe configuration, multiple transmitter-receiver spacing, and frequencies may be used. For example, short-spaced transmitters 102 and receivers 104 may be sensitive to first pipe string 138 (e.g., referring to FIG. 2), while long spaced transmitters 102 and receivers 104 may be sensitive to deeper (2^{nd}, 3^{rd}, etc.) pipes (e.g., first casing 134 and second casing 136).

Analyzing the signal levels at different channels with an inversion scheme, it may be possible to relate a certain received signal to a certain metal loss or gain at each pipe. In addition to loss of metal, other pipe properties such as magnetic permeability and electrical conductivity may also be estimated by inversion. There may be several factors that complicate interpretation of losses: (1) deep pipe signals may be significantly lower than other signals; (2) double dip indications appear for long spaced transmitters 102 and receivers 104; (3) spatial spread of long spaced transmitter-receiver signal for a collar 132 may be long (up to 6 feet); (4) to accurately estimate of individual pipe thickness, the material properties of the pipes (such as magnetic permeability and electrical conductivity) may need to be known with fair accuracy; (5) inversion may be a non-unique process, which means that multiple solutions to the same problem may be obtained and a solution which may be most physically reasonable may be chosen. Due to these complications, an advanced algorithm or workflow may be used to accurately inspect pipe features, for example when more than two pipes may be present in pipe string 138.

During logging operations as EM logging tool 100 traverses across pipe 300 (e.g., referring to FIGS. 3A-3E), an EM log of the received signals may be produced and analyzed. The EM log may be calibrated prior to running inversion to account for the deviations between measurement and simulation (forward model). The deviations may arise from several factors, including the nonlinear behavior of the magnetic core, magnetization of pipes, mandrel effect, and inaccurate well plans. Multiplicative coefficients and constant factors may be applied, either together or individually, to the measured EM log for this calibration. As discussed above, there may be any number of arrangements and spacing between transmitters 102 and/or receivers 104. Additionally, transmitters 102 and/or receivers 104 may be created and/or arranged to add deep azimuthal sensitivity. The control of transmission and recording of sensed signals may be performed at least in part by information handling system 144. In examples, information handling system 144 may preprocess the data digitized from the acquisition system as subsystem of the electronic system. Then send the data to a second information handling system 144, as discussed above.

The proposed system is designed to accommodate a flexible number of transmitters 102, receivers 104, and transceivers for EM logging tool 100. This flexibility enables different modes of operation (which transmitter 102 and which receiver 104 should be used at a time and at which order) either for time domain or frequency domain. Thus, the systems and methods may allow for well logs to be generated in real time. The well logs generated may show anomalies 200 (e.g., referring to FIG. 2) that may be found and identify their location respective to a well plan.

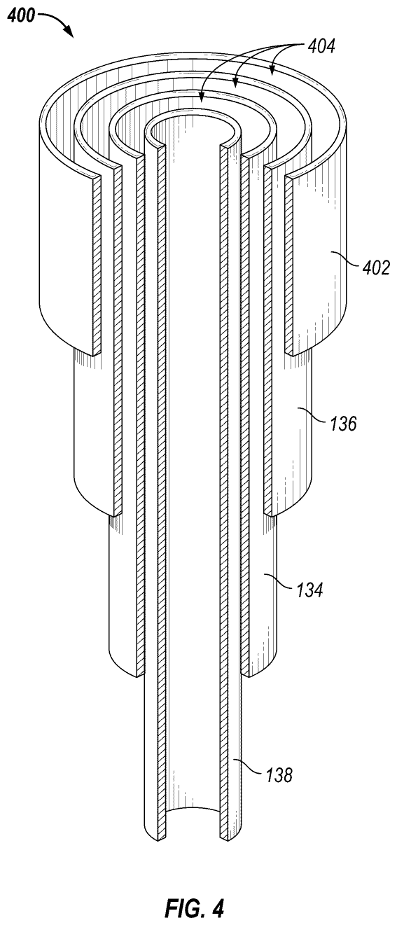

FIG. 4 illustrates an example of a well plan 400 in accordance with some embodiments. Depending on the design of well plan 400, well construction may have between two and four main components. These components include conductor, surface, intermediate and production casings. After completion of the well, tubing may be inserted to pump hydrocarbon products. In this example, well plan 400 may comprise pipe string 138, first casing 134, second casing 136, a conductor casing 402, and wherein cement may be disposed in annulus 404 between each casing. However, it should be noted that well plan 400 may include any number of pipes, casings, tubulars, and/or the like. Well plan 400 is not limited or bound by the four pipes that are displayed in FIG. 4. When EM logging tool 100 is used to monitor the pipe condition a log may be produced.

Monitoring the condition of the casing strings is crucial in oil and gas field operations. As discussed above, EM techniques may be used to inspect pipes, casings, tubulars, and/or the like. Measurements taken by EM logging tool 100 may further be processed by information handling system 144 (e.g., referring to FIG. 1).

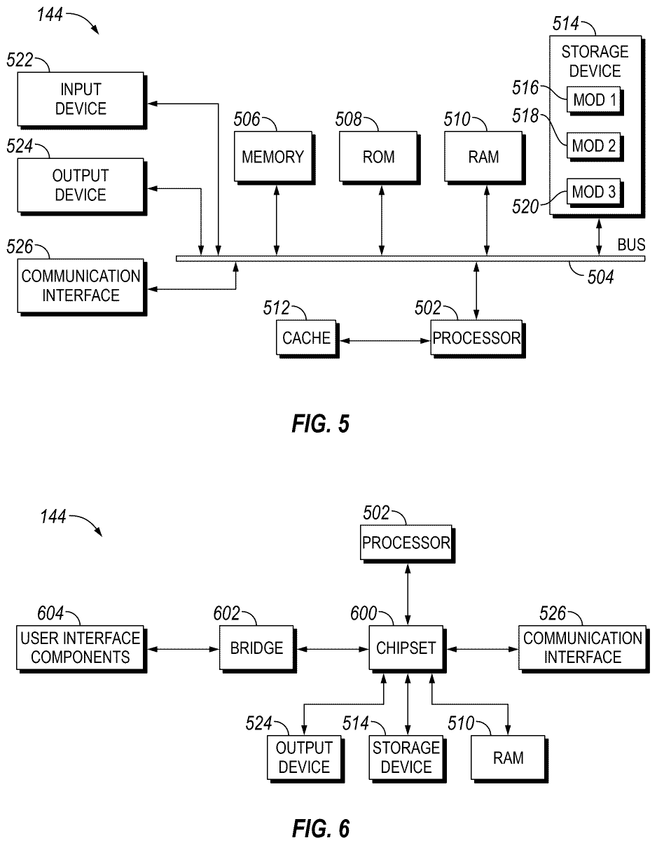

FIG. 5 further illustrates an example information handling system 144 which may be employed to perform various steps, methods, and techniques disclosed herein. Persons of ordinary skill in the art will readily appreciate that other system examples are possible. As illustrated, information handling system 144 includes a processing unit (CPU or processor) 502 and a system bus 504 that couples various system components including system memory 506 such as read only memory (ROM) 508 and random-access memory (RAM) 510 to processor 502. Processors disclosed herein may all be forms of this processor 502. Information handling system 144 may include a cache 512 of high-speed memory connected directly with, in close proximity to, or integrated as part of processor 502. Information handling system 144 copies data from memory 506 and/or storage device 514 to cache 512 for quick access by processor 502. In this way, cache 512 provides a performance boost that avoids processor 502 delays while waiting for data. These and other modules may control or be configured to control processor 502 to perform various operations or actions. Other system memory 506 may be available for use as well. Memory 506 may include multiple different types of memory with different performance characteristics. It may be appreciated that the disclosure may operate on information handling system 144 with more than one processor 502 or on a group or cluster of computing devices networked together to provide greater processing capability. Processor 502 may include any general-purpose processor and a hardware module or software module, such as first module 516, second module 518, and third module 520 stored in storage device 514, configured to control processor 502 as well as a special-purpose processor where software instructions are incorporated into processor 502. Processor 502 may be a self-contained computing system, containing multiple cores or processors, a bus, memory controller, cache, etc. A multi-core processor may be symmetric or asymmetric. Processor 502 may include multiple processors, such as a system having multiple, physically separate processors in different sockets, or a system having multiple processor cores on a single physical chip. Similarly, processor 502 may include multiple distributed processors located in multiple separate computing devices but working together such as via a communications network. Multiple processors or processor cores may share resources such as memory 506 or cache 512 or may operate using independent resources. Processor 502 may include one or more state machines, an application specific integrated circuit (ASIC), or a programmable gate array (PGA) including a field PGA (FPGA).

Each individual component discussed above may be coupled to system bus 504, which may connect each and every individual component to each other. System bus 504 may be any of several types of bus structures including a memory bus or memory controller, a peripheral bus, and a local bus using any of a variety of bus architectures. A basic input/output (BIOS) stored in ROM 508 or the like, may provide the basic routine that helps to transfer information between elements within information handling system 144, such as during start-up. Information handling system 144 further includes storage devices 514 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 514 may include software modules 516, 518, and 520 for controlling processor 502. Information handling system 144 may include other hardware or software modules. Storage device 514 is connected to the system bus 504 by a drive interface. The drives and the associated computer-readable storage devices provide nonvolatile storage of computer-readable instructions, data structures, program modules and other data for information handling system 144. In one aspect, a hardware module that performs a particular function includes the software component stored in a tangible computer-readable storage device in connection with the necessary hardware components, such as processor 502, system bus 504, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 502 executes instructions to perform “operations”, processor 502 may perform the operations directly and/or facilitate, direct, or cooperate with another device or component to perform the operations.

As illustrated, information handling system 144 employs storage device 514, which may be a hard disk or other types of computer-readable storage devices which may store data that are accessible by a computer, such as magnetic cassettes, flash memory cards, digital versatile disks (DVDs), cartridges, random access memories (RAMs) 510, read only memory (ROM) 508, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 522 represents any number of input mechanisms, such as a microphone for speech, a touch-sensitive screen for gesture or graphical input, keyboard, mouse, motion input, speech and so forth. Additionally, input device 522 may receive one or more EM measurements from EM logging tool 100 (e.g., referring to FIG. 1), discussed above. An output device 524 may also be one or more of a number of output mechanisms known to those of skill in the art. In some instances, multimodal systems enable a user to provide multiple types of input to communicate with information handling system 144. Communications interface 526 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 502, that is purpose-built to operate as an equivalent to software executing on a general-purpose processor. For example, the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 508 for storing software performing the operations described below, and random-access memory (RAM) 510 for storing results. Very large-scale integration (VLSI) hardware embodiments, as well as custom VLSI circuitry in combination with a general-purpose DSP circuit, may also be provided.

FIG. 6 illustrates an example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may include a processor 502, representative of any number of physically and/or logically distinct resources capable of executing software, firmware, and hardware configured to perform identified computations. Processor 502 may communicate with a chipset 600 that may control input to and output from processor 502. In this example, chipset 600 outputs information to output device 524, such as a display, and may read and write information to storage device 514, which may include, for example, magnetic media, and solid-state media. Chipset 600 may also read data from and write data to RAM 510. A bridge 602 for interfacing with a variety of user interface components 604 may be provided for interfacing with chipset 600. User interface components 604 may include a keyboard, a microphone, touch detection and processing circuitry, a pointing device, such as a mouse, and so on. In general, inputs to information handling system 144 may come from any of a variety of sources, machine generated and/or human generated.

Chipset 600 may also interface with one or more communication interfaces 526 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 502 analyzing data stored in storage device 514 or RAM 510. Further, information handling system 144 receives inputs from a user via user interface components 604 and executes appropriate functions, such as browsing functions by interpreting these inputs using processor 502.

In examples, information handling system 144 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

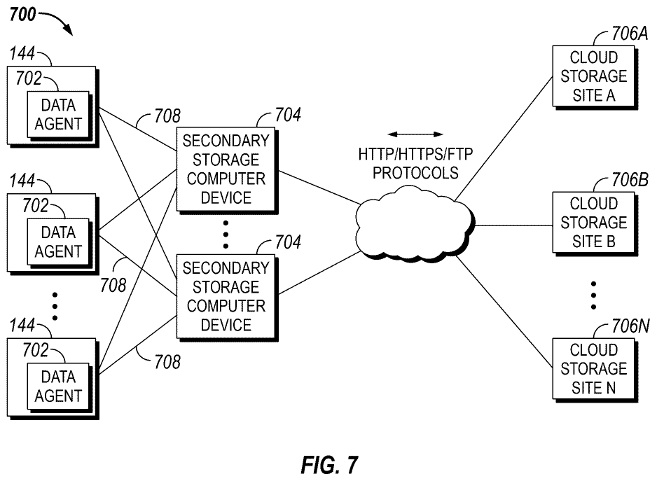

FIG. 7 illustrates an example of one arrangement of resources in a computing network 700 that may employ the processes and techniques described herein, although many others are of course possible. As noted above, an information handling system 144, as part of their function, may utilize data, which includes files, directories, metadata (e.g., access control list (ACLS) creation/edit dates associated with the data, etc.), and other data objects. The data on the information handling system 144 is typically a primary copy (e.g., a production copy). During a copy, backup, archive or other storage operation, information handling system 144 may send a copy of some data objects (or some components thereof) to a secondary storage computing device 704 by utilizing one or more data agents 702.

A data agent 702 may be a desktop application, website application, or any software-based application that is run on information handling system 144. As illustrated, information handling system 144 may be disposed at any rig site (e.g., referring to FIG. 1), off site location, or repair and manufacturing center. The data agent may communicate with a secondary storage computing device 704 using communication protocol 708 in a wired or wireless system. Communication protocol 708 may function and operate as an input to a website application. In the website application, field data related to pre- and post-operations, generated DTCs, notes, and the like may be uploaded. Additionally, information handling system 144 may utilize communication protocol 708 to access processed measurements, operations with similar DTCs, troubleshooting findings, historical run data, and/or the like. This information is accessed from secondary storage computing device 704 by data agent 702, which is loaded on information handling system 144.

Secondary storage computing device 704 may operate and function to create secondary copies of primary data objects (or some components thereof) in various cloud storage sites 706A-N. Additionally, secondary storage computing device 704 may run determinative algorithms on data uploaded from one or more information handling systems 144, discussed further below. Communications between the secondary storage computing devices 704 and cloud storage sites 706A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 706A-N, the secondary storage computing device 704 may also perform local content indexing and/or local object-level, sub-object-level or block-level deduplication when performing storage operations involving various cloud storage sites 706A-N. Cloud storage sites 706A-N may further record and maintain, EM logs, store operational data, and/or provide outputs from determinative algorithms that are located in cloud storage sites 706A-N. In a non-limiting example, this type of network may be utilized as a platform to store, backup, analyze, import, preform extract, transform and load (“ETL”) processes, mathematically process, apply machine learning models, and augment EM measurement data sets.

A machine learning model may be an empirically derived model which may result from a machine learning algorithm identifying one or more underlying relationships within a dataset. In comparison to a physics-based model, such as Maxwell's Equations, which are derived from first principles and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “target values.” Although dependent values may be a necessary component of a dataset for certain algorithms, not all algorithms require a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may include evaluating model performance according to whether the model is over-fit or under-fit. As it may be assumed that all datasets contain some level of error, it may be important to evaluate and optimize the model performance and associated model fit by means of model validation. In general, the variability in model fit (e.g.: whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods include k-fold cross-validation, stratified k-fold cross-validation, bootstrapping, leave-one-out cross-validation, resubstitution, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may include the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may include whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset includes both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may include Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not include a dependent variable as the intended function of this type of algorithm is to identify one or more groupings or clusters within a dataset. In a non-limiting example, algorithms which may be utilized for unsupervised machine learning may include K-means clustering, K-means classification, Fuzzy C-Means, Gaussian Mixture, Hidden Markov Model, Neural Networks, and Hierarchical algorithms.

In examples to determine a relationship using machine learning, a neural network (NN) 800, as illustrated in FIG. 8, may be utilized to locate collars on one or more pipe strings and/or casings in a well plan 400 (e.g., referring to FIG. 4). A NN 800 is an artificial neural network with one or more hidden layers 802 between input layer 804 and output layer 806. As illustrated, input layer 804 may include all extracted electromagnetic responses from EM logging tool 100 (e.g., referring to FIG. 1), and output layers 806 may include pipe information from other sources. During operations, input data 814 is taken by neurons 812 in first layer which then provides an output to the neurons 812 within next layer and so on which provides a final output 816 in output layer 806. Each layer may have one or more neurons 812. The connection between two neurons 812 of successive layers may have an associated weight. The weight defines the influence of the input to the output for the next neuron 812 and eventually for the overall final output. The training process of NN 800 may be utilized to determine azimuthal and axial information of anomalies 200 (e.g., referring to FIG. 2) in high resolution data.

To determine azimuthal and axial information of corrosion in the high resolution data, data processing may be employed at least in part on NN 800, computer network 700, and/or information handling system 144. As described herein, data processing may be used to generate separate quantitative images based on azimuthal and vertical measurements of anomalies 200 (e.g., referring to FIG. 2. Generating quantitative images for separating pipes to indicate the location, size and severity of anomalies 200 (e.g., referring to FIG. 2) remains challenging, especially for overlapping anomalies 200. In embodiments, quantitative images may comprise one or more composite images or one or more separate layers. Overlapping anomalies 200 occur at the same depth of different pipes 300 (e.g., referring to FIGS. 3A-3E), and anomalies 200 on pipe string 138 (e.g., referring to FIG. 3) may overshadow signals from defects on the outer pipe(s) 300, which brings more difficulties for signal and image processing. Also, the double indication effect in the signal may make the processing more complicated and lower the vertical resolution of the results. A data processing workflow is needed to separate the overlapping defects and generate separate images for different pipes 300.

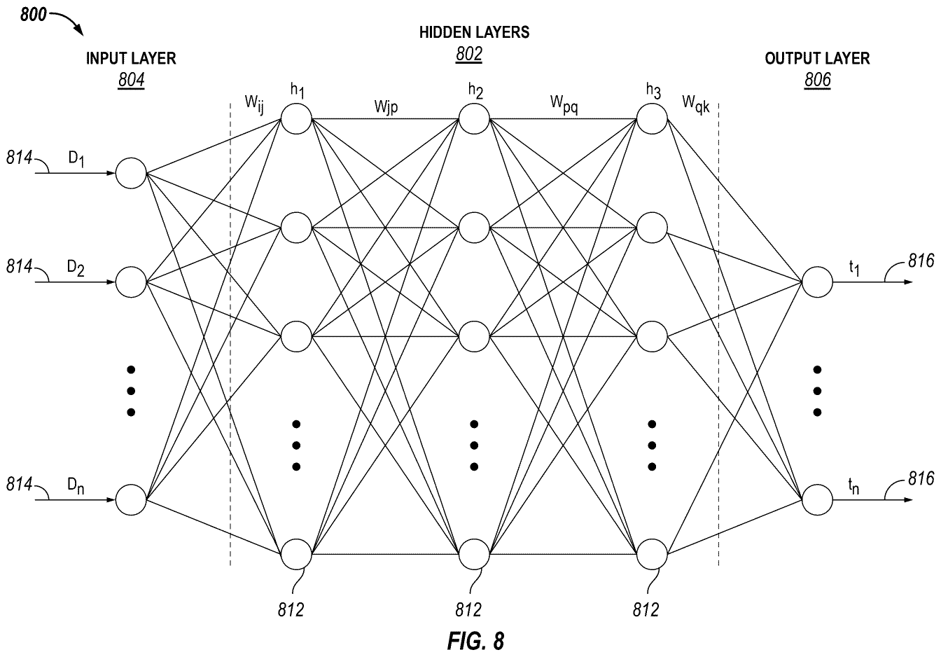

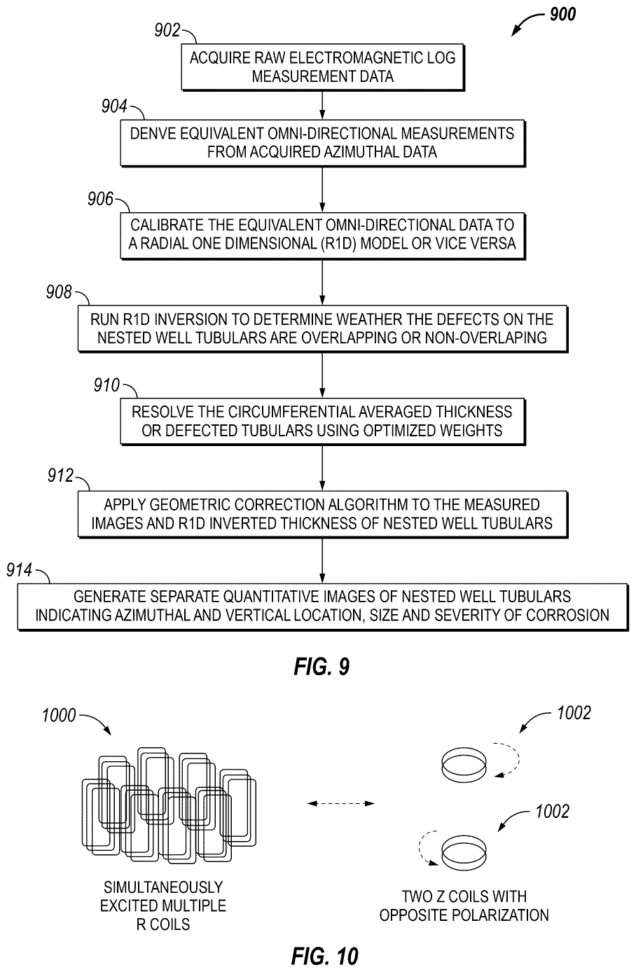

FIG. 9 illustrates workflow 900 for identifying if anomalies 200 are overlapping or non-overlapping. Overlapping anomalies 200 is defined as defects occurring at different tubulars (e.g., pipe string 138 and/or casing string 108) but at the same or proximate vertical location, optionally including partial overlaps. It should be noted that workflow 900 may at least in part be performed on information handling system 144. Additionally, workflow 900 may be utilized to resolve the thickness of pipe 300 with anomalies 200 using optimized weights. For a given tubular (e.g., pipe string 138 and/or casing string 108), weights may be applied to pixels in a qualitative image such that the weighted average of the pixels within the vertical resolution window of the tool centered at a given depth adds up to the thickness or metal loss estimated from the radial 1D inversion at that depth for that given tubular. Different sets of weights may be optimized for different tubulars. Workflow 900 may further generate separate quantitative images of nested well tubulars indicating azimuthal and vertical location, size, and severity of anomalies 200 on information handling system 144.

Workflow 900 may begin with block 902, in which raw electromagnetic logging data may be acquired using EM logging tool 100 (e.g., referring to FIG. 1). During measurement operations, EM logging tool 100 may be disposed within pipe string 138 (e.g., referring to FIGS. 1 & 2) without removing any casing (i.e., pipes 300) to obtain multi-frequency and multi-spacing logs. EM logging tool 100 may take measurements utilizing the methods and system described above, in either the frequency or time domain. Eddy current measurement methods may allow for multiple pipes characterizations. Different depths of penetration, axial and vertical resolutions may be achieved via several receivers 104 and several transmitters 102 placed at various positions, as described above. It should be noted that receivers 104 and/or transmitter 102 may be any type described above, have any configuration described above, and operate and function according to the disclosure above. Further receivers 104 and/or transmitters 102 may be transceivers. Transmitters 102 that are placed at a shorter distance from receivers 104, may measure the response due to pipe string 138 with better axial and vertical resolution. Transmitters 102 that are at longer distances from receivers 104 may measure responses of pipes 300 but with degraded resolution. Thus, an electromagnetic log generated from measurement operations of EM logging tool 100 may be processed to invert all measurements with one measurement run.

In block 904, equivalent omni-directional measurements from acquired azimuthal data from block 902 may be derived. Azimuthal data may be acquired using an array of sensors deployed at different azimuthal positions and/or pointing into different azimuthal directions within the tool. The derivation of equivalent omni-directional measurements from acquired azimuthal data is based on the equivalence shown in FIG. 10. In FIG. 10 the simultaneously excited r coil crown 1000 may mimic two z coils 1002 with opposite polarity. Therefore, by summing along all the r-coil transmitters or receivers in the r-coil crown 1000, an omnidirectional measurement may be formed. As described herein, EM logging tool 100 may comprise a 4 z-coil equivalent, a 3 z-coil equivalent, or an optional omni-directional section as a 2 z-coil model.

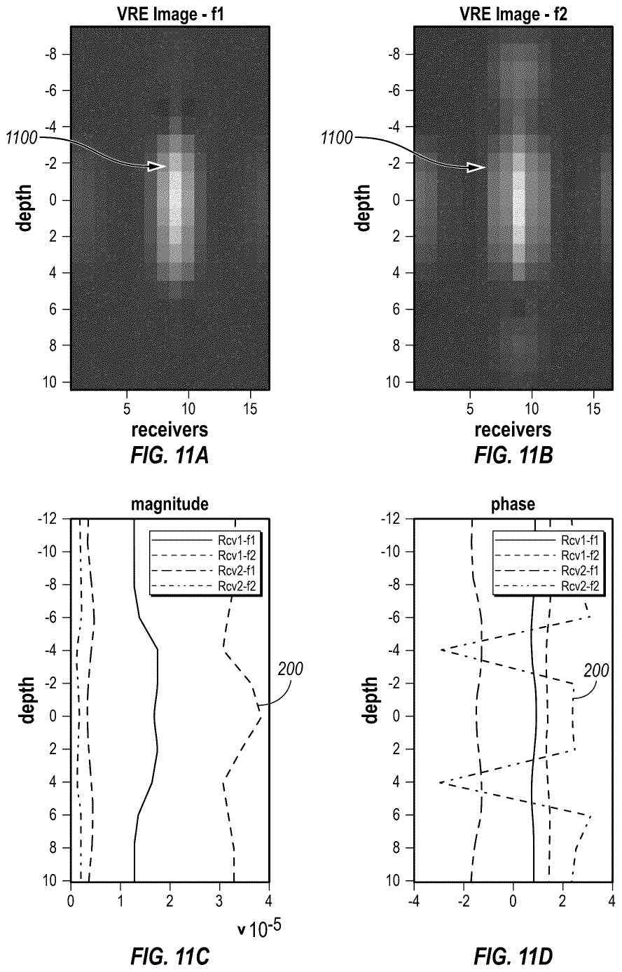

The measurement in block 904 may be graphed in different examples to illustrate the different configurations of EM logging tool 100. For example, as illustrated in FIGS. 11A-11D, two pipes 300 may be measured using EM logging tool 100. A through hole 1100, as illustrated in FIGS. 11A and 11B, with 3.2-inch diameter is located on first pipe of FIG. 11A at depth 0 inch and azimuth 180 degree, and through hole 1100 with 4.2-inch diameter is located on the second pipe of FIG. 11B at depth 0 inch and azimuth 180 degree. The data acquired from EM logging tool 100 for anomalies 200, such as through hole 1100 is graphed in FIG. 11A which shows the measured image at frequency “1” containing both azimuthal and vertical information. FIG. 11B is a graph showing the measured image at frequency “2”. The graph of FIG. 11C shows the omni-directional measurements of magnitude of anomalies 200 using different receivers 104 at different frequencies. FIG. 11D shows the omni-directional measurements of phase of anomalies 200 using different receivers 104 at different frequencies.

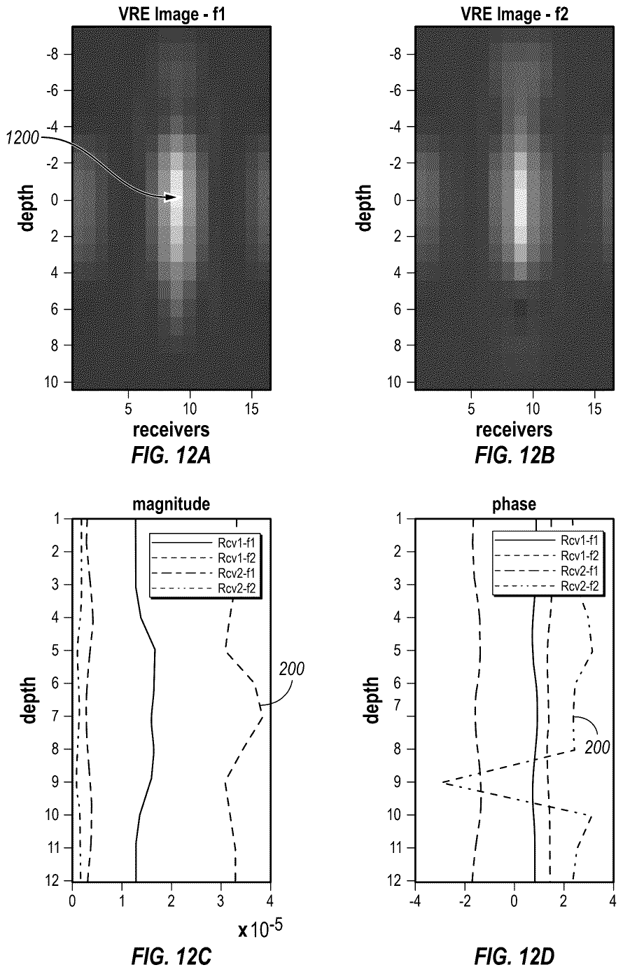

As illustrated in FIGS. 12A-12D, there are two pipes 300 that may be measured using EM logging tool 100. One through hole 1200 with 3.2-inch diameter is located on a first pipe in FIG. 12A at depth 0 inch and azimuth 180 degree, and no anomalies 200 are located on the second pipe of FIG. 12B. The data acquired from EM logging tool 100 for through tubing anomalies evaluation is shown using graph in FIG. 12A which shows the measured image at frequency “1” containing both azimuthal and vertical information. FIG. 12B is a graph showing the measured image at frequency “2”. FIG. 12C is a graph showing the omni-directional measurements of magnitude, phase, or a real and an imaginary value of an anomaly 200 using different receivers 104 at different frequencies. The graph of FIG. 12D shows the omni-directional measurements of phase of anomaly 200 using different receivers 104 at different frequencies.

Referring back to FIG. 9, block 906 may take the data from block 904 and calibrate the equivalent omni-directional measurement data to a reduced one-dimensional (R1D) model or vice versa. In example, the R1D processing model comprises a deterministic model, a machine learning model, a deep learning model, or any combination thereof. Additionally, R1D may be a radial one-dimensional model, a one-dimensional inversion model, a two-dimensional inversion model, or a three-dimensional inversion model. In order to calculate the thickness of pipe 300 with anomalies 200, the data processing may be based on comparing the data acquired in a given depth range to the data obtained in a nominal thickness range. Variation from the nominal may be modeled by a fast forward model code that uses a one-dimensional radial model to describe the geometry. This RID model does not include the nonlinear behavior of the magnetic core in EM logging tool 100 and the possible magnetization of the innermost tubular, such as pipe string 138. To make the thickness variations in the numerical model to be equivalent to the thickness variations in the measurements, the measured data needs to be calibrated to the R1D model or vice versa.

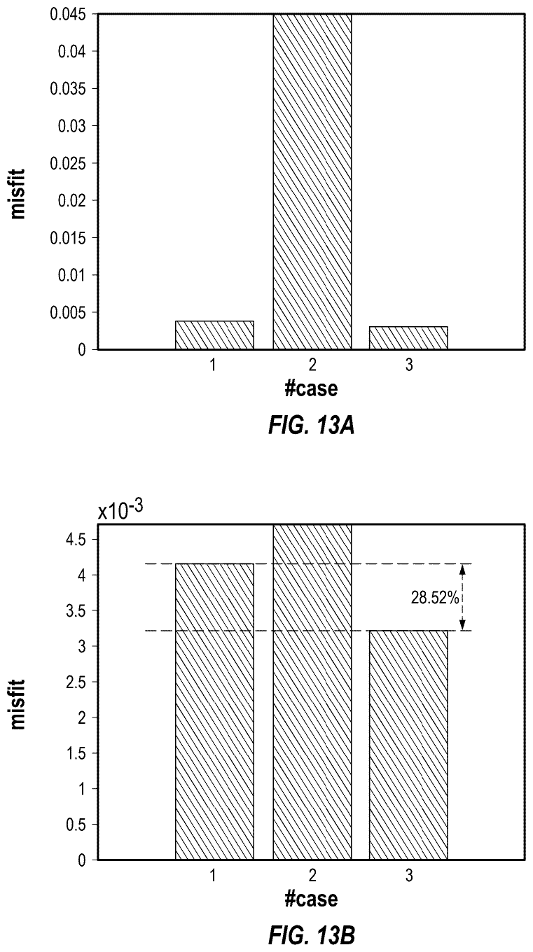

In block 908, an R1D inversion may be run to determine whether the anomalies 200 of the pipes 300 may be overlapping or non-overlapping. For example, FIG. 13A is a graph that shows the R1D inversion misfit for different measurement scenarios. In examples. A deterministic inversion or a probabilistic inversion may be applied to vertical measurement or a combined azimuthal-vertical datasets to determine if overlapping may be present. In scenario 1, it may be assumed all anomalies 200 are on the first (innermost) pipe only. In scenario 2, it may be assumed all anomalies 200 on the second (outermost) pipe only. In scenario 3, it may be assumed that all anomalies 200 are overlapping defects, which occur at the same vertical depth of the two pipes. As can be seen, misfit3 is the smallest, followed by misfit1, and misfit2 is the largest. A threshold may be set, for example, equal to 2%. Here 2% is just an example, but could be any appropriate level of significance such as 1%, 2%, 5%, 10% etc. If misfit3 is more than 2% smaller than misfit1, then anomalies 200 may be determined as overlapping anomalies 200. FIG. 13B is a graph that shows the zoomed-in plot of the misfit. As may be seen, based on calculation,

$$( misfit 1 - misfit 3 ) / misfit 3 \times 100 \% = 28.52 \% \qquad ( 6 )$$

which is larger than the threshold 2%. Therefore, it is determined that the anomalies in this case are overlapping defects.

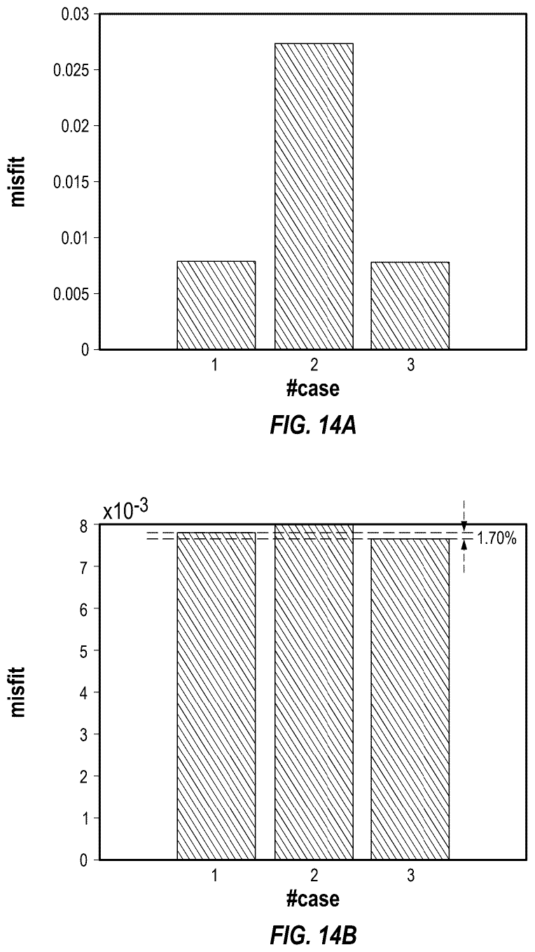

FIG. 14A are graphs that show the R1D inversion misfit for different cases of scenario 2, described above. As illustrated, misfit3 is the smallest, followed by misfit1, and misfit2 is the largest. FIG. 14B illustrates the zoomed-in plot of the misfit. Based on calculation,

$$( misfit 1 - misfit 3 ) / misfit 3 \times 100 \% = 1.7 \% \qquad ( 7 )$$

which is smaller than the threshold of 2%. Therefore, it is determined that the anomaly in this case is non-overlapping defects.

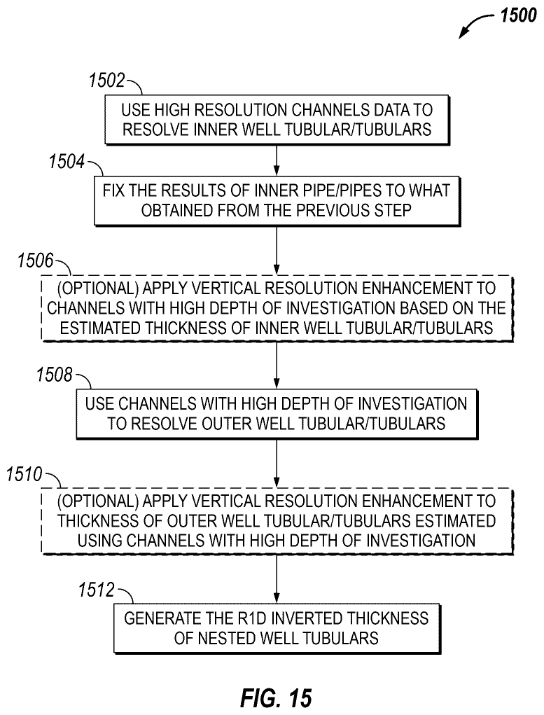

Referring back to FIG. 9, in block 910, that data from block 908 may be utilized to resolve the thickness of defected pipes 300 using optimized weights. FIG. 15 illustrates a workflow 1500 to resolve the thickness of defected pipe using optimized weights. It should be noted that workflow 1500 may be performed at least in part on information handling system 144. Workflow 1500 may begin with block 1502. In block 1502 a high-resolution channels data may be used to resolve the thickness of the inner well/tubulars. The high-resolution channels usually refer to the combination of transmitters 102 and receivers 104 with relatively short distances and operating at high frequences. In block 1504, the results of inner pipe/pipes to what obtained from the previous step may be fixed. In block 1506, which may be optional, a vertical resolution enhancement may be applied to channels with high depth of investigation based on the estimated thickness of pipe string 138 and/or pipes 300. The channels with high depth of investigation usually refer to the combination of transmitters 102 and receivers 104 with relatively long distances and operating at low frequences. The possible double peak effect in the data could be eliminated based on the impulse response of the estimated thickness of the inner well tubular/tubulars. The method of vertical resolution enhancement may be performed by deconvolution, machine-learning based method, and/or deep learning-based methods.

In block 1508, channels with high depth of investigation may be used to resolve outer well tubular/tubulars. In block 1510, an optional block, a vertical resolution enhancement may be applied to a thickness of outer well tubular/tubulars estimated using channels with high depth of investigation. In block 1512, the R1D inverted thickness of nested well tubulars may be generated.

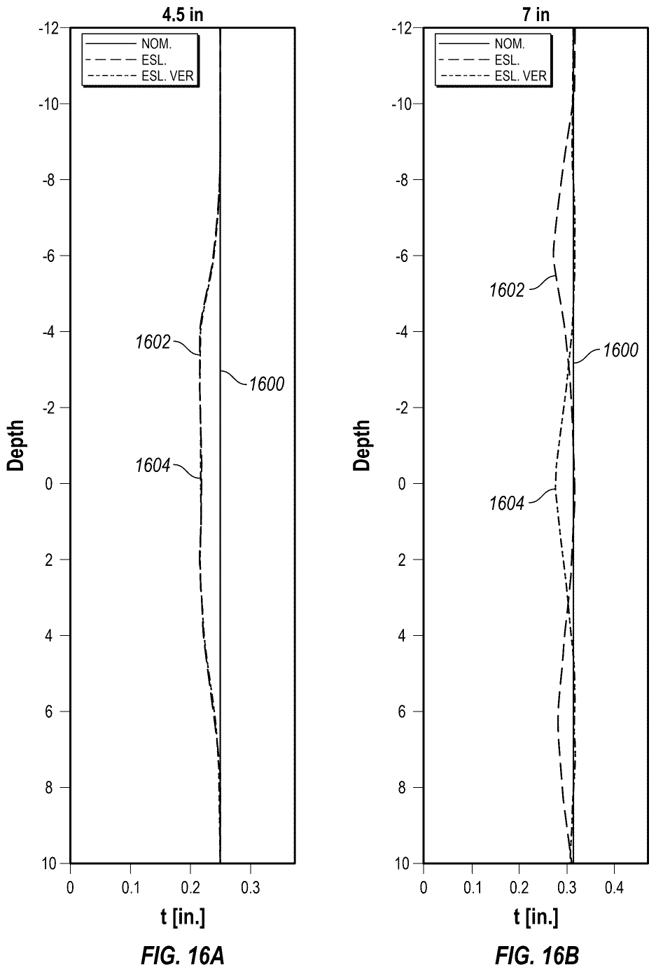

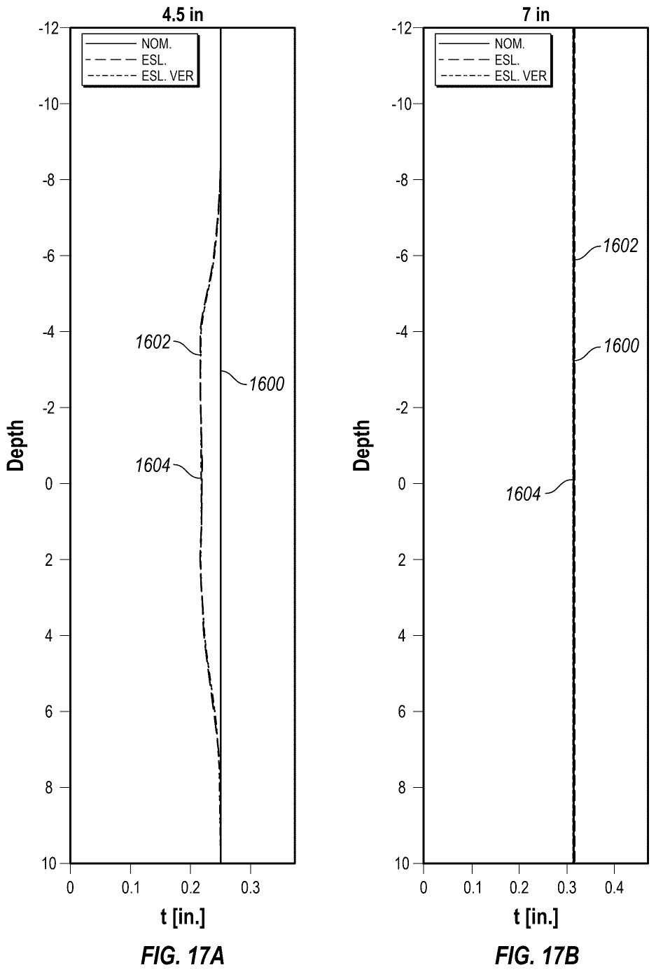

FIGS. 16A and 16B are graphs illustrating the use of workflow 1500. For example, the RID inverted thickness for different pipes of example 1 with overlapping anomalies 200. FIGS. 17A and 17B are graphs illustrating the use of workflow 1500. For example, the R1D inverted thickness for different pipes of example 2 with non-overlapping anomalies 200. For FIGS. 16A, 16B, 17A, & 17B, line 1600 is a nominal thickness of pipe 300. Line 1602 shows the estimated thickness without vertical resolution enhancement. Line 1604 shows the estimated thickness with vertical resolution enhancement.

Referring back to FIG. 9, block 912 may apply geometric correction algorithm to the measured images and R1D inverted thickness of nested well tubulars. In block 912, azimuthal log images in conjunction with the log of circumferentially averaged attribute. Additionally, at least one scaled image wherein the image is a scaled version of the azimuthal log image such that the circumferential average equivalent of the scaled image at any given depth matches the log of circumferentially averaged attribute at that depth. The circumferential average equivalent of the scaled image is computed as a weighted sum of the scaled image pixels within a sliding window with an axial length proportional to the vertical resolution of the non-azimuthal tool. The scaling may be linear, polynomial, or non-linear scaling. Computing the scaled image may comprise solving an optimization problem to determine the contrast of each pixel. Logs of circumferentially averaged attributes for each individual tubular are used to obtain individual scaled images for each one of the tubulars. In this disclosure, the circumferentially averaged attribute is the R1D inverted thickness or metal loss.

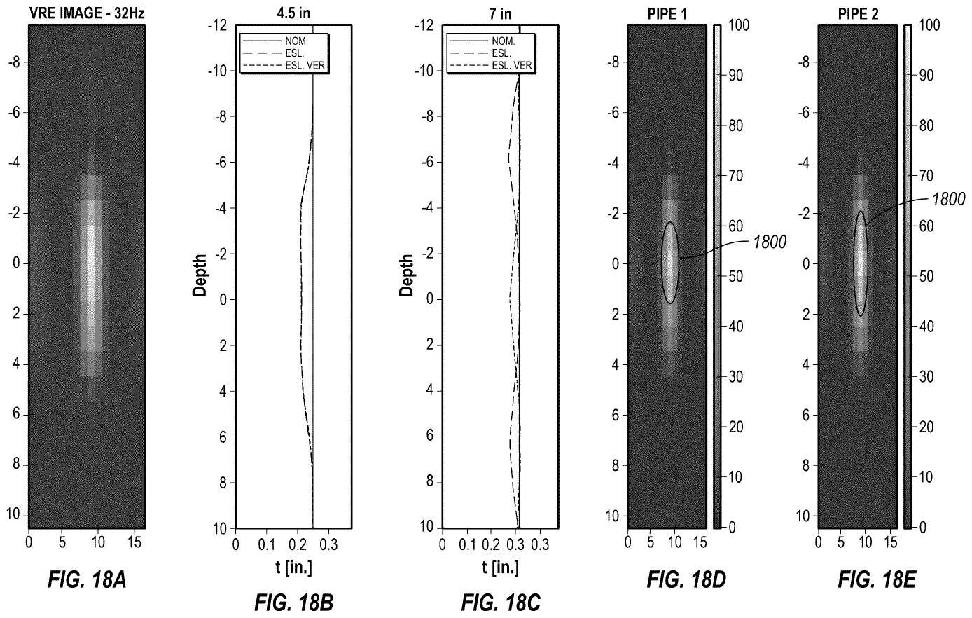

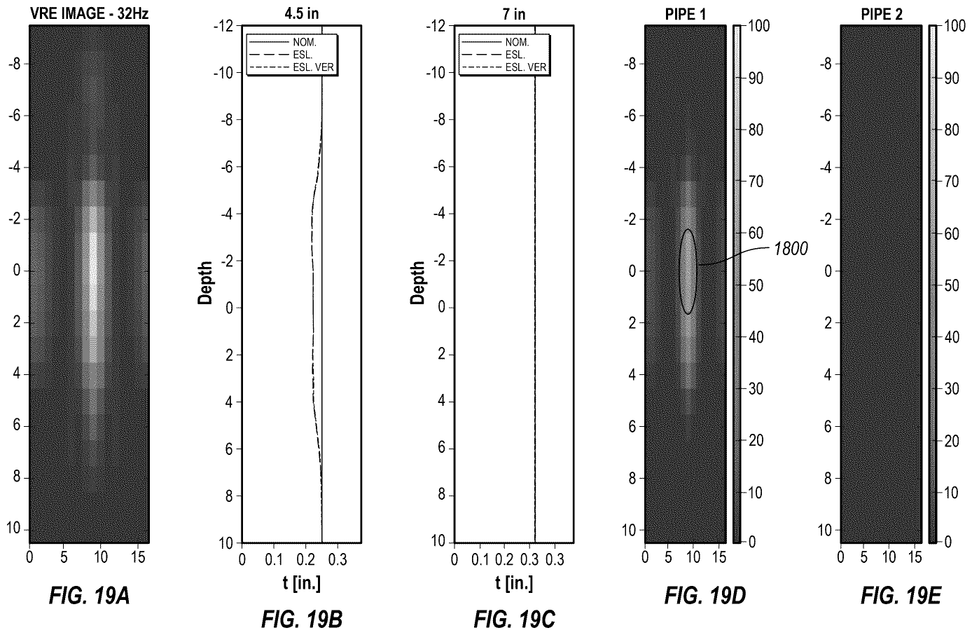

In block 914, separate inverted images of nested well tubulars may be generated. FIGS. 18A-18E are graphs showing the final results of workflow 900 wherein there may be overlapping anomalies 200. FIGS. 19A-19E are graphs showing the final results of workflow 900 with non-overlapping anomalies 200. FIGS. 18A and 19A are the measured image. FIGS. 18B, 18C, 19B, and 19C are graphs showing the R1D inverted thickness of pipes 300. FIGS. 18D, 18E, 19D, and 19E are graphs showing the inverted images of measurement area. R1D inverted thicknesses may be used to determine if there exists overlapping defect based on the ratio or difference of metal loss estimated on the different pipes. That classification of overlapping versus non-overlapping defects is used to filter estimated thickness logs for zones with non-overlapping defects by removing any artifacts that may exist on the non-defected tubular. Those filtered thickness logs may be used along with the qualitative azimuthal images to compute separated quantitative images for each one of the tubulars (e.g., pipe string 138 and/or casing string 108). In examples, quantitative image may comprise an azimuthal location, a vertical location, or a size for the first tubular or the second tubular. For a given tubular, weights may be applied to pixels in the qualitative image such that the weighted average of the pixels within the vertical resolution window of EM logging tool 100 centered at a given depth adds up to the thickness or metal loss estimated from the radial 1D inversion at that depth for that given tubular. Different sets of weights may be optimized for different tubulars thus yielding different quantitative images for the different tubulars. Additionally, quantitative images may be presented in an uncertainty map. Area 1800 may indicate the real size and location of anomalies 200 on pipes 300. The display of anomalies 200 in graphical form may also be displayed in other manners to help in analysis.

For example, as described below, methods and systems may extrapolate a mathematical approach of 1D inversion for logging measurements. The 3D inversion for interpreting the logging data compares the measurement results against 3D Finite Element simulations results. This process may comprise of inspecting a lookup table of 3D simulations results, looking for the minimum difference between the measurement data with the numerical data. Once the smallest difference is found, the synthetic data may represent a candidate of defect combination for the real scenario. The lookup table might be precomputed prior to running EM logging tool 100, or alternatively, might be computed on the fly following a hierarchical approach to minimize the number of forward model computations.

The proposed 3D inversion method may be customizable to a type of EM logging tool 100 that may be used in measurement operations. Such pre-knowledge is required for the 3D FEM simulations run and database creation. That is, the look-up table comprises running simulations of a set of combinations of anomalies 200. Which may comprise the following degrees of freedom: anomaly presence, number of anomalies, anomaly size, anomalies depth, anomalies azimuth, anomalies shape (or area) and anomalies thickness (or metal loss thickness) for each pipe 300 (e.g., referring to FIG. 2) under evaluation. The combination of solutions may comprise EM logging tool 100 variables as well, for instance, in case of EM logging tool 100 under frequency domain: excitation frequency, transmitter sensor center to receiver sensor center distance, tool eccentricity. Moreover, environment parameters may be added, such as pipes thickness, pipes material properties, pipes eccentricity ratio, and pipes eccentricity angle. Therefore, the complete table of solutions may be very large, depending on the assumptions performed, also known as a design of experiments input variables.

Improvements over current technology are found in generating separate inverted images based on azimuthal and vertical measurements of corrosion on at least two nested well tubulars. Additionally, the methods and system may determine whether the defects are overlapping or non-overlapping as well as resolve the thickness of the defected pipe using optimized weights. Methods and systems may be able to generate separate quantitative images of nested well tubulars indicating azimuthal and vertical location, size, and severity of corrosion.

The preceding description provides various examples of the systems and methods of use disclosed herein which may contain different method steps and alternative combinations of components.
Statement 1: A method may comprise disposing an electromagnetic (EM) logging tool in a wellbore. The EM logging tool may comprise at least one transmitter disposed on the EM logging tool and at least one receiver disposed on the EM logging tool. The method may further comprise transmitting an electromagnetic field from the at least one transmitter into one or more tubulars to energize the one or more tubulars with the electromagnetic field thereby producing an eddy current that emanates from the one or more tubulars, measuring the eddy current in the one or more tubulars with the at least one receiver on at least one channel to obtain a plurality of measurements, or sending the plurality of measurements to an information handling system. The information handling system may be configured to form an EM log from the plurality of measurements.
Statement 2: The method of statement 1, wherein the at least one transmitter is one or more coils, one or more antennas, or one or more electromagnetic elements.
Statement 3: The method of any previous statement, wherein the at least one receiver is one or more coils, one or more antennas, or one or more electromagnetic elements.
Statement 4: The method of any previous statement, wherein the electromagnetic field is a continuous wave, a pulsed wave, or a broadband of signals.
Statement 5: The method of any previous statement, wherein the plurality of measurements are taken in a time-domain, a frequency-domain, or a hybrid domain.
Statement 6: A non-transitory machine-readable media having instruction stored thereon that are executable by an information handling system. The instructions may comprise receive a plurality of measurements as an input, wherein the plurality of measurements comprise an azimuthal data set, derive an omni-directional measurement data set from the azimuthal data set; calibrate the omni-directional measurement data set to a reduced one-dimensional (RID) processing model, resolve a thickness of a first tubular and a second tubular with the R1D processing model, or apply a geometric correction algorithm to the first tubular and the second tubular. The instructions may further comprise generate a quantitative image that shows an azimuthal location, a vertical location, or a size for the first tubular or the second tubular.
Statement 7: The non-transitory machine-readable media of statement 6, wherein the R1D processing model is a radial one dimensional model.
Statement 8: The non-transitory machine-readable media of any previous statements 6 or 7, wherein the R1D processing model comprises a one-dimensional inversion model, a two-dimensional inversion model, or a three-dimensional inversion model.
Statement 9: The non-transitory machine-readable media of any previous statements 6-8, wherein the R1D processing model comprises a deterministic model, a machine learning model, a deep learning model, or any combination thereof.
Statement 10: The non-transitory machine-readable media of any previous statements 6-9, wherein the plurality of measurements have a magnitude, a phase, or a real and an imaginary value.
Statement 11: The non-transitory machine-readable media of any previous statements 6-10, wherein the calibrate the omni-directional measurement data set is performed at least in part using one or more measurements of a portion of a tubular with a nominal thickness.
Statement 12: The non-transitory machine-readable media of any previous statements 6-11, further comprising instructions to identify a first defect on the first tubular and a second defect on the second tubular occur at least in part at a proximate vertical location.
Statement 13: The non-transitory machine-readable media any previous statements 6-12, further comprising instructions to apply a deterministic inversion or a probabilistic inversion to a vertical measurement or a combined azimuthal-vertical datasets.
Statement 14: The non-transitory machine-readable media any previous statement 6-13, further comprising instructions to integrate an azimuthal data set and a vertical data set to one or more measured images to form an output.
Statement 15: The non-transitory machine-readable media of statement 14, wherein the output is presented a one or more composite images or one or more separate layers for the first tubular.
Statement 16: The non-transitory machine-readable media of statement 15, wherein the output is presented as an uncertainty map.
Statement 17: The non-transitory machine-readable media any previous statement 6-14, wherein the resolve a thickness may further comprise use a high resolution data to resolve one or more properties first tubular as a first dataset, fix the one or more properties of the first tubular to what is obtained from the first dataset, or use one or more channels with a high depth of investigation to resolve the one or more properties of a second tubular outside the first tubular.
Statement 18: The non-transitory machine-readable media of statement 17, further comprising apply a vertical resolution enhancement to the one or more channels with the high depth of investigation.
Statement 19: The non-transitory machine-readable media of statements 17 or 18, further comprising apply a vertical resolution enhancement to a thickness of the second tubular.
Statement 20: The non-transitory machine-readable media of statement 19, wherein the vertical resolution enhancement is a deconvolution, a machine-learning based method, or a deep learning based method.

It should be understood that, although individual examples may be discussed herein, the present disclosure covers all combinations of the disclosed examples, including, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing an electromagnetic (EM) logging tool in a wellbore, wherein the EM logging tool comprises:
at least one transmitter disposed on the EM logging tool; and
at least one receiver disposed on the EM logging tool;
transmitting an electromagnetic field from the at least one transmitter into one or more tubulars to energize the one or more tubulars with the electromagnetic field thereby producing an eddy current that emanates from the one or more tubulars;
measuring the eddy current in the one or more tubulars with the at least one receiver on at least one channel to obtain a plurality of measurements; and
sending the plurality of measurements to an information handling system, wherein the information handling system is configured to:
form an EM log from the plurality of measurements.

2. The method of claim 1, wherein the at least one transmitter is one or more coils, one or more antennas, or one or more electromagnetic elements.

3. The method of claim 1, wherein the at least one receiver is one or more coils, one or more antennas, or one or more electromagnetic elements.

4. The method of claim 1, wherein the electromagnetic field is a continuous wave, a pulsed wave, or a broadband of signals.

5. The method of claim 1, wherein the plurality of measurements are taken in a time-domain, a frequency-domain, or a hybrid domain.

6. A non-transitory machine-readable media having instruction stored thereon that are executable by an information handling system, the instruction comprising:
receive a plurality of measurements as an input, wherein the plurality of measurements comprise an azimuthal data set;
derive an omni-directional measurement data set from the azimuthal data set;
calibrate the omni-directional measurement data set to a reduced one-dimensional (R1D) processing model;
resolve a thickness of a first tubular and a second tubular with the R1D processing model;
apply a geometric correction algorithm to the first tubular and the second tubular; and
generate a quantitative image that shows an azimuthal location, a vertical location, or a size for the first tubular or the second tubular.

7. The non-transitory machine-readable media of claim 6, wherein the R1D processing model is a radial one dimensional model.

8. The non-transitory machine-readable media of claim 6, wherein the R1D processing model comprises a one-dimensional inversion model, a two-dimensional inversion model, or a three-dimensional inversion model.

9. The non-transitory machine-readable media of claim 6, wherein the R1D processing model comprises a deterministic model, a machine learning model, a deep learning model, or any combination thereof.

10. The non-transitory machine-readable media of claim 6, wherein the plurality of measurements have a magnitude, a phase, or a real and an imaginary value.

11. The non-transitory machine-readable media of claim 6, wherein the calibrate the omni-directional measurement data set is performed at least in part using one or more measurements of a portion of a tubular with a nominal thickness.

12. The non-transitory machine-readable media of claim 6, further comprising instructions to identify a first defect on the first tubular and a second defect on the second tubular occur at least in part at a proximate vertical location.

13. The non-transitory machine-readable media of claim 6, further comprising instructions to apply a deterministic inversion or a probabilistic inversion to a vertical measurement or a combined azimuthal-vertical datasets.

14. The non-transitory machine-readable media of claim 6, further comprising instructions to integrate an azimuthal data set and a vertical data set to one or more measured images to form an output.

15. The non-transitory machine-readable media of claim 14, wherein the output is presented a one or more composite images or one or more separate layers for the first tubular.

16. The non-transitory machine-readable media of claim 15, wherein the output is presented as an uncertainty map.

17. The non-transitory machine-readable media of claim 6, wherein the resolve a thickness comprises:
use a high resolution data to resolve one or more properties first tubular as a first dataset;
fix the one or more properties of the first tubular to what is obtained from the first dataset; and
use one or more channels with a high depth of investigation to resolve the one or more properties of a second tubular outside the first tubular.

18. The non-transitory machine-readable media of claim 17, further comprising apply a vertical resolution enhancement to the one or more channels with the high depth of investigation.

19. The non-transitory machine-readable media of claim 17, further comprising apply a vertical resolution enhancement to a thickness of the second tubular.

20. The non-transitory machine-readable media of claim 19, wherein the vertical resolution enhancement is a deconvolution, a machine-learning based method, or a deep learning based method.
